(19) United States
(12) Patent Application Publication
(10) Pub. No.: US 2011/0282573 A1
(43) Pub. Date: Nov. 17, 2011

(54) Route planning method

(75) Inventor: Shih-Chieh Ting, Chung Ho City (TW)

(73) Assignee: GLOBALSAT TECHNOLOGY CORPORATION, Chung Ho City (TW)

(21) Appl. No.: 12/662,921

(22) Filed: May 12, 2010

(51) Int. Cl. G01C 21/00; G01S 19/45; G06F 12/00

(52) U.S. Cl. 701/201; 711/104; 711/E12.001

(57) ABSTRACT

A route planning method used with an electronic device formed of a processor, a transmission interface, an I/O port and a storage unit and a GPS formed of a CPU, a transmission interface, a storage unit, a display unit, a satellite positioning unit and an antenna is disclosed to input the location data of the predetermined destination into the electronic device through the input/output port of the electronic device so that the processor of the electronic device produces and compresses a route planning data and then transmits the route planning data to the GPS for enabling the GPS to convert the geographic coordinate data of the current location received from the satellite and the compressed route panning data received from the electronic device into a planar or 3D navigation map for display on the display unit thereof.

### BACKGROUND OF THE INVENTION

1. Field of the Invention

The present invention relates to satellite positioning navigation technology and more particularly, to a route planning method for navigation, which achieves route planning work by means of an electronic device and then enables the route planning data to be compressed and then transmitted by the electronic device to a GPS for position mapping so that the CPU of the GPS can be simplified, saving the manufacturing cost.

2. Description of the Related Art

Following fast development of modern technology, physical distance is even less of a hindrance to the real-time communicative activities of people, and therefore social spheres are greatly expanded, and therefore the concept of global village arises. In order to provide reliable positioning, navigation, and timing services to worldwide users on a continuous basis in all weather, day and night, anywhere on or near the Earth, GPS (global positioning system) was created.

A GPS receives satellite signals from a number of artificial satellites to determine the current location (longitude, latitude, and altitude to within a few meters. Receivers calculate the precise time as well as position, which can be used as a reference for scientific experiments. GPS is intensively used in cars, boats and other transportation vehicles for positioning to assist traveling or navigation. A global navigation satellite system (GNSS) provides satellite (GPS) based positioning, navigation, timing and automated dependent surveillance services.

Nowadays, advanced cars are equipped with a global navigation satellite system (GNSS) as a standard equipment. An advanced global navigation satellite system (GNSS) provides 3D actual view simulation and different route planning modes. Thus, a large program capacity is necessary, complicating the computation procedure. Because much data storage capacity and a relatively higher operating power of central processing speed are necessary, the cost of the system is high. People really cannot afford to buy an expensive global navigation satellite system (GNSS).

Therefore, it is desirable to provide a route planning method for navigation, which eliminates the aforesaid problems.

### SUMMARY OF THE INVENTION

The present invention has been accomplished under the circumstances in view. It is the main object of the present invention to provide a route planning method for navigation, which simplifies GPS's positioning work, thereby saving GPS's manufacturing cost.

To achieve this and other objects of the present invention, a route planning method is used with an electronic device and a GPS. The electronic device comprises a processor, a transmission interface, an I/O port and a storage unit. The GPS comprises a CPU (central processing unit), a transmission interface, a storage unit, a display unit, a satellite positioning unit and an antenna. The route planning method is to input the location data of the predetermined destination into the electronic device through the input/output port of the electronic device so that the processor of the electronic device produces and compresses a route planning data by means of a route planning data compression algorithm and then transmits the route planning data to the GPS for enabling the GPS to convert the geographic coordinate data of the current location received from the satellite and the compressed route panning data received from the electronic device into a planar or 3D navigation map for display on the display unit thereof. The application of the route planning data compression algorithm compresses the route planning data into a less number of recording points. Because the amount of data to be stored is reduced, data storage work becomes easy and data transmission speed is relatively accelerated.

Further, the GPS is equipped with a supplementary unit. When the user is driving through a cave or tunnel or when the clouds look thick, the satellite signal receiving operation of the antenna may be interrupted. At this time, the supplementary unit that is electrically connected to the CPU of the GPS helps computing the currently traveling route and direction.

### BRIEF DESCRIPTION OF THE DRAWINGS

FIG. 1 is a circuit block diagram of a GPS and an electronic device according to the present invention.

FIG. 2 is a schematic drawing, showing wireless communication between the GPS and the electronic device according to the present invention.

FIG. 3 is a flow chart of a route planning method according to the present invention.

FIG. 4 is a flow chart of a route planning data compression algorithm according to the present invention (I).

FIG. 5 is a flow chart of a route planning data compression algorithm according to the present invention (II).

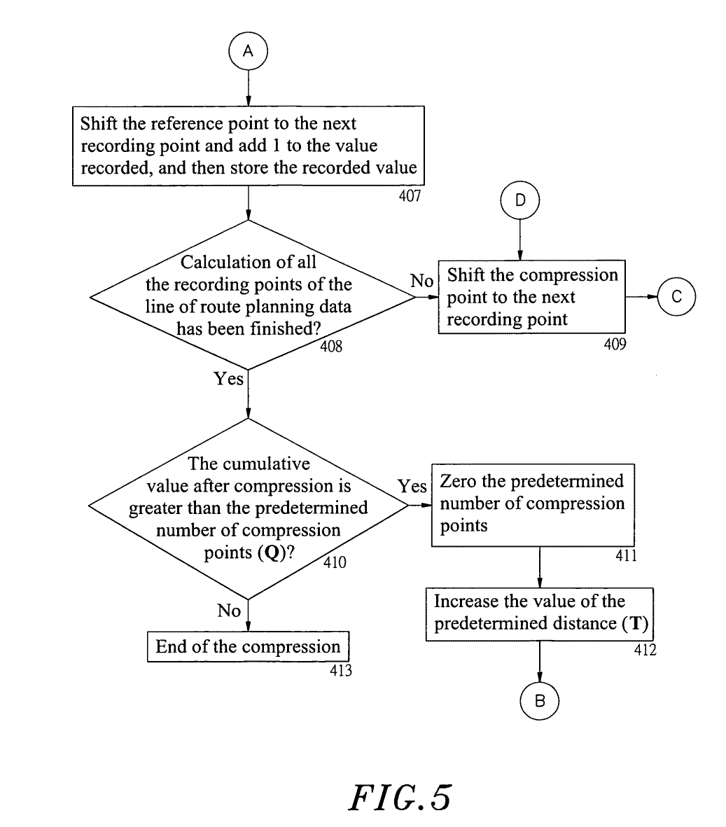

FIG. 6 is a schematic drawing, explaining the rout planning data compression algorithm according to the present invention.

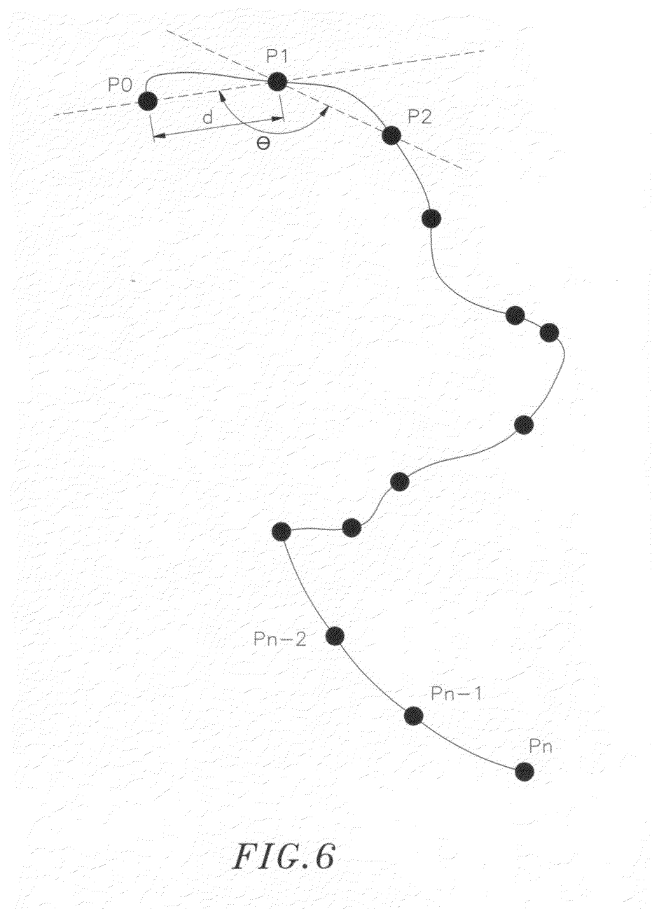

### DETAILED DESCRIPTION OF THE PREFERRED EMBODIMENT

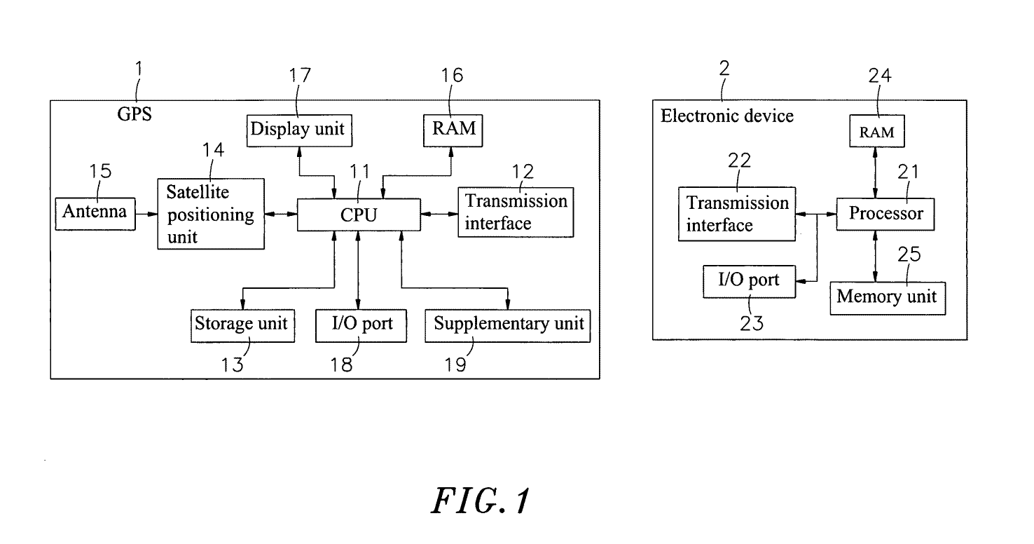

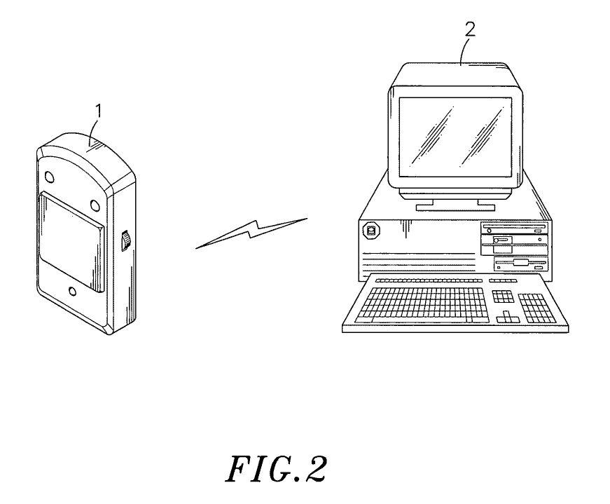

Referring to FIGS. 1 and 2, a route planning method is used with a GPS (global positioning system) 1 and an electronic device 2.

The GPS 1 comprises a CPU 11, a transmission interface 12 electrically connected with the CPU 11 and adapted for receiving and transmitting signals, a storage unit 13 electrically connected with the CPU 11 and adapted for storing data, a satellite positioning unit 14 and an antenna 15 electrically connected with the CPU 11, a RAM (random access memory) 16 electrically connected with the CPU 11 for allowing stored data to be accessed in any order, a display unit 17 electrically connected with the CPU 11 and adapted for displaying data, and an input/output port 18 and a supplementary unit 19 respectively electrically connected with the CPU 11.

The electronic device 2 comprises a processor 21, a transmission interface 22 and an input/output port 23 electrically connected with the processor 21 for data transmission, a RAM (random access memory) 24 electrically connected with the processor 21 for allowing stored data to be accessed in any order and a memory unit 25 electrically connected with the processor 21 for storing data.

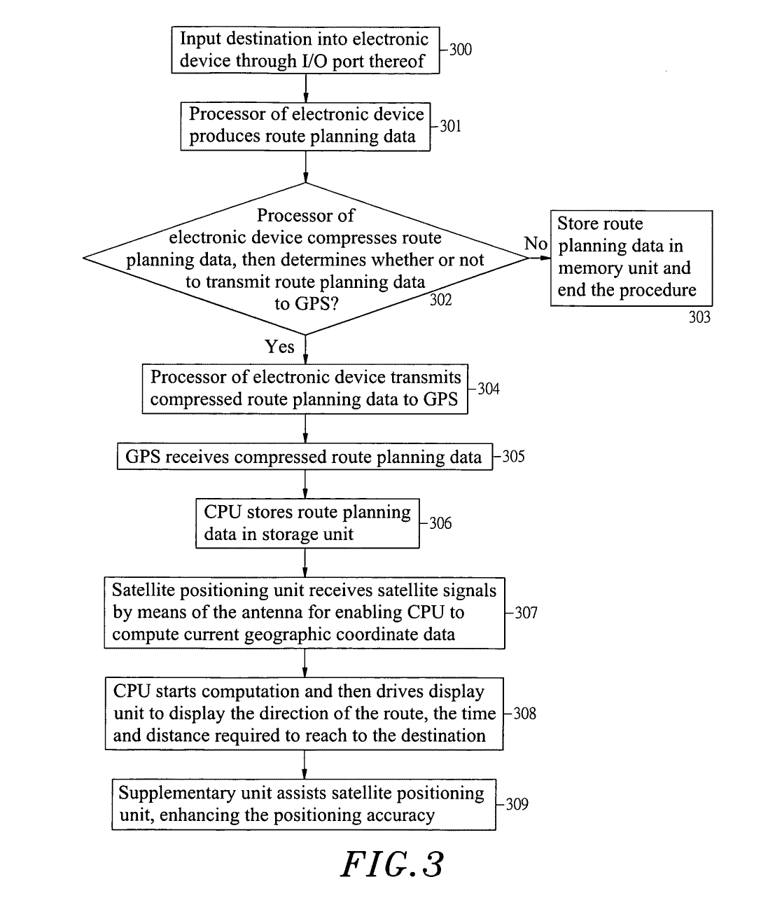

Referring to FIG. 3 and FIG. 1 again, the route planning method includes the steps as follows:
(300) Input the location data of the predetermined destination into the processor 21 of the electronic device 2 through the input/output port 23.
(301) The processor 21 produces a route planning data.
(302) The processor 21 compresses the route planning data by means of a route planning data compression algorithm, and then determines whether or not to transmit the compressed route planning data to the GPS 1, and then proceeds to step (304) when positive, or step (303) when negative.
(303) The processor 21 stores the compressed route planning data in the memory unit 25 and ends the procedure.
(304) The processor 21 transmits the compressed route planning data to the transmission interface 12 of the GPS 1 through the transmission interface 22.
(305) The CPU 11 of the GPS 1 receives the compressed route planning data from the transmission interface 12.
(306) The CPU 11 of the GPS 1 stores the compressed route planning data in the storage unit 13 temporarily.
(307) The satellite positioning unit 14 of the GPS 1 receives satellite signals by means of the antenna 15 for enabling the CPU 11 to compute the current geographic coordinate data.
(308) The CPU 11 of the GPS 1 starts computation and then drives the display unit 17 to display the direction of the route, the time and distance required to reach to the destination.
(309) The supplementary unit 19 assists the satellite positioning unit 14, enhancing the positioning accuracy.

The user connects an input device, for example, a keyboard or computer mouse (not shown) to the input/output port 23 of the electronic device 2, and then use the input device to input the location data of the predetermined destination into the processor 21 of the electronic device 2 for causing the processor 21 to start computation and to produce a route planning data (containing, for example, multiple landmarks or the optimal travel route to the destination) and to store the tour planning data in the RAM 24. Thereafter, the processor 21 of the electronic device 2 compresses the route planning data by means of a route planning data compression algorithm, and then stores the compressed route planning data in the memory unit 25. Further, the processor 21 can transmit the compressed route planning data to the transmission interface 12 of the GPS 1 through the transmission interface 22. The transmission interface 22 of the electronic device 2 matches the transmission interface 12 of the GPS 1. These transmission interfaces 12 and 22 can be a wireless design using RF or Bluetooth technology. Alternatively, these transmission interfaces 12 and 22 can be connected by a connection cable.

The CPU 11 of the GPS 1 receives the compressed route planning data from the electronic device 2 by means of the transmission interface 12, and stores the compressed route planning data in the storage unit 13. Further, the satellite positioning unit 14 of the GPS 1 receives satellite signal from the satellite by means of the antenna 15 for enabling the CPU 11 to compute the longitude and latitude coordinates of the current location. After computation, the CPU 11 stores the geographic coordinate data of the current location and the compressed route planning data from the storage unit 13 in the RAM 16 temporarily, and then converts the geographic coordinate data of the current location and the compressed route panning data into a planar or 3D navigation map, and then drives the display unit 17 (LCD monitor or touch panel) to display the map, the direction of the route, and the time and distance required to reach to the destination. By means of the electronic device 2 to process route planning operation and then to compress and transmit the processed route planning data to the GPS 1, the GPS 1 simply needs to handle the positioning work. Thus, the CPU 11 operation speed can be accelerated and the capacity of the storage unit 13 of the GPS 1 can be minimized, lowering the manufacturing cost of the GPS 1 to attract consumers to buy.

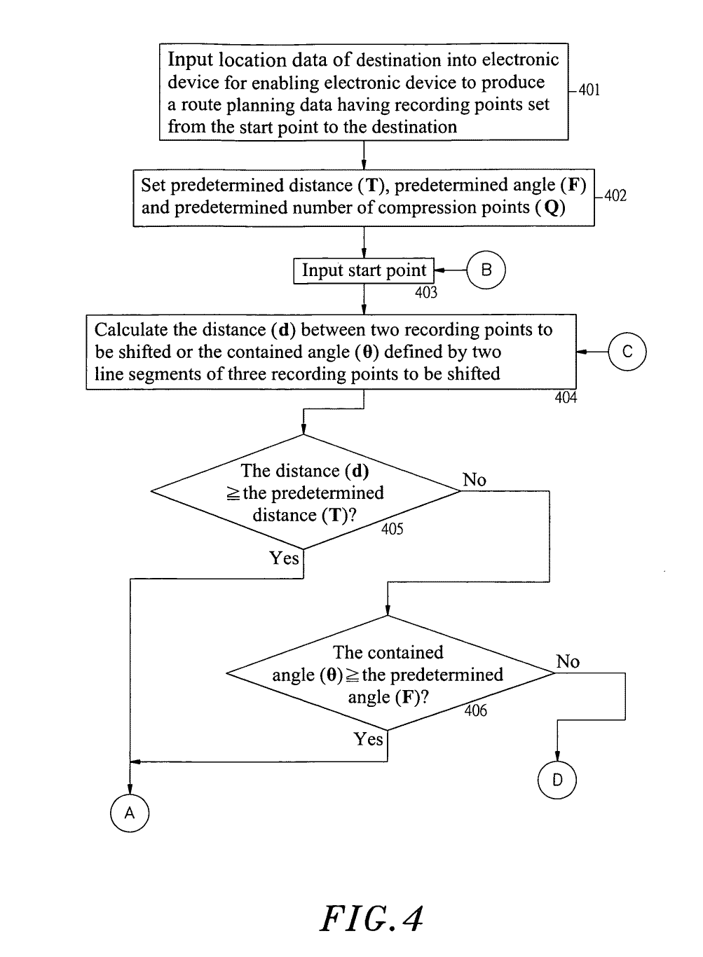

Referring to FIGS. 4˜6 and FIG. 3 again, the electronic device 2 compresses the produced route planning data subject to the procedure as follows:

The user sets a predetermined distance (T) (T can be, for example, 10 meters or 100 meters), a predetermined angle (F) (F can be, for example, 120° or 130° but not equal to or greater than 180°) and a predetermined number of compression points (Q) (Q can be, for example, 50 points). The route planning data corresponds to one line (for example, 10 kilometers) that has a predetermined number of recording points (for example, 100 recording points). Assume the first recording point (P0) is the start point, a recording distance (d) will be produced when shifting the start point (P0) to the first next recording point (P1), a recording distance (d1) will be produced when shifting the first next recording point (P1) to the second next recording point (P2), a recording distance (d2) will be produced when shifting the second next recording point (P2) to the third next recording point (P3), and so on. At this time, the predetermined distance (T) is explained to have a length value when compared to the length of the recording distances (d, d1, d2, d3, d4 . . . dn).

When shifting a number of the aforesaid recording points (P1, P2, P3 . . . Pn), three recording points (for example, P0, P1, P2; P1, P2, P3; or P1, P3, P4) can be linked to form two line segments that define a recording angle (θ). At this time, the predetermined angle (F) is explained to have an angle value when compared to the angle of the recording angle (θ). Further, when the predetermined number of recording points (for example, 100 recording points) of the line of the aforesaid route planning data segment is compressed to, for example, 50 recording points, this value (50 recording points) becomes the predetermined number of compression points (Q).

The aforesaid route planning data compression algorithm is performed subject to the following steps:
(401) Input the location data of the predetermined destination into the electronic device 2 for enabling the electronic device 2 to produce a line of route planning data that has a number of recording points set from the start point to the destination.
(402) Set a predetermined distance (T), a predetermined angle (F) and a predetermined number of compression points (Q) subject to said line of route planning data.
(403) Input the start point.
(404) Calculate the distance (d) between two recording points to be shifted or the contained angle (θ) defined by two line segments of three recording points to be shifted.
(405) Determine whether or not the distance (d) is greater than or equal to the value of the predetermined distance (T), and then proceed to step (407) when positive, or step (406) when negative.
(406) Determine whether or not the contained angle (θ) is greater than or equal to the value of the predetermined angle (F), and then proceed to step (407) when positive, or step (409) when negative.
(407) Shift the reference point to the next recording point and add 1 to the value recorded, and then store the recorded value.
(408) Determine whether or not the calculation of all the recording points of the line has been finished, and then proceed to step (410) when positive, or step (409) when negative.
(409) Return to step (404) and then shift the reference point to the next recording point, and then calculate the angle and distance again.
(410) Determine whether or not the cumulative value after compression is greater than the predetermined number of compression points (Q), and then proceed to step (411) when positive, or step (413) when negative.
(411) Zero the predetermined number of compression points (Q).
(412) Increase the value of the predetermined distance (T) and then return to step (403).
(413) End the compression.

Thus, the location data of the predetermined destination is inputted into the electronic device 2 for enabling the electronic device 2 to produce a line of route planning data that has a number of recording points (for example, 100 recording points) set from the start point to the destination. Thereafter, set a predetermined distance (T) for comparison with the length between two recording points, a predetermined angle (F) for comparison with the contained angle between the two line segments of three recording points and a predetermined number of compression points (Q) by which a number of the recording points are to be compressed. Thereafter, input the start point (P0 in which P0=K0) and set the value (n) and the value (Z), and then calculate the distance (d) between two recording points to be shifted or the contained angle (θ) defined by two line segments of three recording points to be shifted. This calculation is made subject to expression d=dist (K[Z], P[n+1]) in which d is the recording distance; K[Z] is the reference point; P[n+1] is the n+1 recording point; the n+1 recording point is the last shifting point. Assume the initial reference point is first recording point (P0) and P[n+1] is the n+1 recording point (P1), a recording distance (d) will be produced from the reference point (P0) to the n+1 recording point (P1), and another recording distance (d1) will be produced when shifting the recording point (P1) to the next recording point (P2); when the reference point is shifted from the recording point (P0) to the recording point (P1), another recording distance (d2) will be produced between the recording point (P0) and the recording point (P1). At this time, the predetermined distance (T) can be expressed by a length value that shows a ratio elative to the recording distances (d, d1, d2 . . . dn).

Further, a straight line is formed between the reference point (K[Z]=K[0]) and the front shifting point (P[n+1]=P[1]), and (P[n+2]=P[2]) becomes the rear shifting point, and another straight line is produced between the front shifting point (P[n+1]=P[1]) and the rear shifting point (P[n+2]=P[2]), and therefore these two straight lines define a contained angle (θ) subject to the expression:

θ=∠( K̅[̅Z̅]̅,̅p̅[̅n̅+̅1̅]̅,̅P̅[̅n̅+̅2̅]̅).

Thereafter, determine whether or not the value of the recording distance (d) is greater than the value of the predetermined distance (T). If the value of recording distance (d) is not greater than the value of the predetermined distance (T), determine whether or not the value of the contained angle (θ) is greater than the value of the predetermined angle (F). If the value of the contained angle (θ) is not greater than the value of the predetermined angle (F), shift the front shifting point from the second recording point (P1) to the third recording point (P2), and then shift the rear shifting point from the third recording point (P2) to the fourth recording point (P3).

For example, the cumulative number of shifts (Z)=40 and the predetermined number of compression points (Q)=50, it means the recording points has been compressed from the original 100 points to 40 points. Because 40 points<50 points, the number of points after compression is smaller than the predetermined number of compression points (Q), and the procedure is done. If the cumulative number of shifts (Z)=60 and the predetermined number of compression points (Q)=50, the number of points after compression is greater than the predetermined number of compression points (Q), the setting must be done again, and the value of the predetermined distance (T) must be increased so that the aforesaid procedure can be performed again till that the value of the cumulative number of shifts (Z) become smaller than the predetermined number of compression points (Q).

Further, the CPU 11 of the GPS 1 is electrically connected with the supplementary unit 19. The supplementary unit 19 can be an electronic compass or G-sensor that assists the satellite positioning unit 14, enhancing the positioning accuracy. Further, when the user is driving through a cave or tunnel or when the clouds look thick, the satellite positioning unit 14 may be unable to receive satellite signals through the antenna 15. At this time, the supplementary unit 19 helps computing the currently traveling route and direction.

In conclusion, the route planning method of the present invention is characterized by the following technical features:
(1) By means of using the electronic device 2 to process route planning operation and then to compress the processed route planning data and to transmit the processed route planning data to the GPS 1, the GPS 1 simply needs to handle the positioning work. Thus, the CPU 11 can be simplified, saving the manufacturing cost.
(2) When the user is driving through a cave or tunnel or when the clouds look thick, the satellite signal receiving operation of the antenna 15 may be interrupted or weak. At this time, the supplementary unit 19 that is electrically connected to the CPU 11 helps computing the currently traveling route and direction.
(3) The application of the route planning data compression algorithm compresses the route planning data into a less number of recording points. Because the amount of data to be stored is reduced, data storage work becomes easy and data transmission speed is relatively accelerated.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A route planning method used with an electronic device and a GPS (global positioning system), said electronic device comprising a processor, a transmission interface, an I/O port and a storage unit, said electronic device being controllable to transmit signals to said GPS, said GPS comprising a CPU (central processing unit), a transmission interface, a storage unit, a display unit, a satellite positioning unit and an antenna, the route planning method comprising the steps of:
(A) Input the location data of a predetermined destination into said processor of said electronic device through the input/output port of said electronic device.
(B) The processor of said electronic device produces a route planning data.
(C) The processor of said electronic device compresses said route planning data by means of a route planning data compression algorithm, and then determines whether or not to transmit the compressed route planning data to said GPS, and then proceeds to step (E) when positive, or step (D) when negative.
(D) The processor of said electronic device stores the compressed route planning data in the memory unit of said electronic device and ends the procedure.
(E) The processor of said electronic device transmits the compressed route planning data to the transmission interface of said GPS through the transmission interface of said electronic device.
(F) The CPU of said GPS stores the compressed route planning data in the storage unit of said GPS temporarily.
(G) The satellite positioning unit of said GPS receives satellite signals by means of said antenna for enabling the CPU of said GPS to compute the current geographic coordinate data.
(H) The CPU of said GPS drives said display unit to display the direction of the route, the time and distance required to reach to the destination.

2. The route planning method as claimed in claim 1, wherein said GPS further comprises a supplementary unit electrically connected with said CPU, said supplementary unit being selected from a group consisting of electronic compass and G-sensor.

3. The route planning method as claimed in claim 1, wherein said GPS further comprises an I/O port electrically connected with said CPU for signal transmission with an external device.

4. The route planning method as claimed in claim 1, wherein said GPS further comprises a random access memory electrically connected with said CPU.

5. The route planning method as claimed in claim 1, wherein the transmission interface of said electronic device and the transmission interface of said GPS are wireless designs using RF or Bluetooth technology.

6. The route planning method as claimed in claim 1, wherein the transmission interface of said electronic device and the transmission interface of said GPS are wired designs.

7. The route planning method as claimed in claim 1, wherein said electronic device further comprises a random access memory electrically connected to said processor,

8. The route planning method as claimed in claim 1, wherein the route planning data compression algorithm employed in step (C) comprises the steps of:
(C1) Input the location data of said predetermined destination into said electronic device for enabling said electronic device to produce a route planning data that has a number of recording points set from the start point to the destination.
(C2) Set a predetermined distance (T), a predetermined angle (F) and a predetermined number of compression points (Q) subject to said route planning data.
(C3) Input the start point.
(C4) Calculate the distance (d) between two said recording points to be shifted or the contained angle (θ) defined by two line segments of three said recording points to be shifted.
(C5) Determine whether or not the distance (d) is greater than or equal to the value of the predetermined distance (T), and then proceed to step (C7) when positive, or step (C6) when negative.
(C6) Determine whether or not the contained angle (θ) is greater than or equal to the value of the predetermined angle (F), and then proceed to step (C7) when positive, or step (C9) when negative.
(C7) Shift the reference point to the next recording point and add 1 to the value recorded, and then store the recorded value.
(C8) Determine whether or not the calculation of all the recording points of the line has been finished, and then proceed to step (C10) when positive, or step (C9) when negative.
(C9) Return to step (C4) and then shift the reference point to the next recording point, and then calculate the angle and distance again.
(C10) Determine whether or not the cumulative value after compression is greater than the predetermined number of compression points (Q), and then proceed to step (C11) when positive, or step (C13) when negative.
(C11) Zero the predetermined number of compression points (Q).
(C12) Increase the value of the predetermined distance (T) and then return to step (C3).
(C13) End the compression.
